(19) United States
(12) Patent Application Publication
(10) Pub. No.: US 2016/0042710 A1
(43) Pub. Date: Feb. 11, 2016

(54) DISPLAY DEVICE AND METHOD FOR DRIVING THE SAME

(71) Applicant: SHENZHEN CHINA STAR OPTOELECTRONICS TECHNOLOGY CO. LTD., Shenzhen (CN)

(72) Inventor: Xiangyang XU, Shenzhen (CN)

(21) Appl. No.: 14/416,810

(22) PCT Filed: Jun. 16, 2014
(86) PCT No.: PCT/CN2014/079973

§ 371 Date: Jan. 23, 2015

(30) Foreign Application Priority Data
Jun. 9, 2014 (CN) 201410253886.0

(51) Int. Cl. G09G 3/36

(52) U.S. Cl. CPC G09G 3/3677; G09G 2310/0278; G09G 2300/0426

(57) ABSTRACT

The present disclosure discloses a display device and a method for driving the same, which belongs to the field of display technology and therefore solves the technical problem of low charging speed of a liquid crystal display in the prior art.

The display device comprises a plurality of scan lines and data lines that are staggered with each other vertically and horizontally, a plurality of sub-pixel units defined by the scan lines and data lines, an additional scan line, and an additional TFT, wherein the additional TFT has its gate connected to the additional scan line, its source connected to the pixel electrode of a first sub-pixel unit, and its drain connected to the pixel electrode of a second sub-pixel unit, and wherein the polarities of voltages on the pixel electrodes of the first sub-pixel unit and the second sub-pixel unit are opposite to each other.

The present application claims benefit of Chinese patent application CN 201410253886.0, entitled “Display device and method for driving the same” and filed on Jun. 9, 2014, the entirety of which is incorporated herein by reference.

### FIELD OF THE INVENTION

The present disclosure relates to the field of display technology, in particular to a display device and a method for driving the same.

### BACKGROUND OF THE INVENTION

As the display technology develops, liquid crystal displays have become the most commonly used display device.

In the display process of a liquid crystal display, the scan lines (gate lines) each are successively enabled. During a period when one scan line is enabled (during one scan cycle), the data lines each input data signals to the pixel electrodes located in this line of sub-pixel units, i.e., to charge the liquid crystal capacitors located in this line of sub-pixel units.

On the other hand, due to existence of impurity molecules in liquid crystal molecules, the liquid crystal molecules are easily subject to polarization if driven under a DC voltage for a long time, thus affecting the display effects thereof. Hence, liquid crystal displays are usually driven under AV voltage. This AV voltage drive can be specifically divided into the modes of common electrode line reversion, frame reversion, column reversion, dot reversion, etc.

Among the above drive modes, the dot reversion mode produces the best display quality, but requires the longest charging time for the liquid crystal capacitors thereof. As illustrated in FIG. 1, in one frame image, the pixel electrodes of any two adjacent sub-pixel units 1 have voltages of opposite polarities. In a next frame image, the pixel electrode of each sub-pixel unit 1 is to be charged with a voltage of a polarity opposite to that in the previous frame image. The voltage of pixel electrode varies rather greatly, and therefore requires a rather long charging time. That is, only a low charging speed can be obtained.

The scan cycle of a liquid crystal display is turning shorter as the refresh rate and resolution thereof are constantly improved. As such, a higher charging speed of the liquid crystal display is demanded, so that the liquid crystal capacitor of the sub-pixel unit can be charged to a voltage of a predetermined grayscale in one scan cycle. However, existing liquid crystal displays are of low charging speed, especially in the case of the dot reversion drive mode, where the requirements of high refresh rate and resolution can hardly be satisfied.

### SUMMARY OF THE INVENTION

According to the present disclosure, it aims to provide a display device and a method for driving the same, and therefore solves the technical problem of a low charging speed for existing liquid crystal displays.

The present disclosure provides a display device, comprising a plurality of scan lines and data lines that are staggered with each other vertically and horizontally, a plurality of sub-pixel units defined by the scan lines and data lines, an additional scan line, and an additional TFT,

wherein the additional TFT has its gate connected to the additional scan line, its source connected to the pixel electrode of a first sub-pixel unit, and its drain connected to the pixel electrode of a second sub-pixel unit, and

wherein the polarities of voltages on the pixel electrodes of the first sub-pixel unit and the second sub-pixel unit are opposite to each other.

Preferably, the first sub-pixel unit and the second sub-pixel unit are adjacent to each other.

In one embodiment, the display device comprises n scan lines, m data lines, and n×m sub-pixel units. The first sub-pixel unit is located at line i, column j, and the second sub-pixel unit is located at line i+1, column j, wherein 1≦i≦n−1, and 1≦j≦m.

Moreover, when 2≦i≦n−1, the additional scan line is connected to scan line i−1.

In another embodiment, the display device comprises n scan lines, m data lines, and n×m sub-pixel units. The first sub-pixel unit is located at line i, column j, and the second sub-pixel unit is located at line i, column j+1, wherein 1≦i≦n, and 1≦j≦m−1.

Moreover, when 2≦i≦n, the additional scan line is connected to scan line i−1.

Furthermore, when i=1, the additional scan line is connected to scan line n.

The present disclosure further provides a method for driving a display device, comprising:

Step 1: enabling an additional scan line so as to electrically connect the pixel electrodes of a first sub-pixel unit and a second sub-pixel unit via an additional TFT; and

Step 2: enabling a corresponding scan line so as to input data signals to the pixel electrodes of the first sub-pixel unit and the second sub-pixel unit.

In one embodiment of the present disclosure, the method comprises:

enabling a first scan line, during a first scan cycle of Step 2, so as to input a data signal to the pixel electrode of the first sub-pixel unit; and

enabling a second scan line, during a second scan cycle of Step 2, so as to input a data signal to the pixel electrode of the second sub-pixel unit.

In still another embodiment, the method comprise enabling the scan line, during the first scan cycle of Step 2, so as to input data signals to the pixel electrodes of the first sub-pixel unit and the second sub-pixel unit located in the same line.

The present disclosure brings about the following advantageous effects. According to the present disclosure, in the display process, the pixel electrodes of the first sub-pixel unit and the second sub-pixel unit can be electrically connected via the additional TFT by enabling the additional scan line in advance. In this case, the voltages on the two pixel electrodes with opposite polarities can be neutralized with each other to be approximate or equal to zero. Afterwards, when the corresponding scan line is enabled, the corresponding data lines will input data signals to the pixel electrodes of the two sub-pixel units, and the voltages thereon will be charged from zero (or approximate zero) to values of correspondingly predetermined grayscales. As a result, voltage variation on the pixel electrodes is reduced, and the charging speed is improved, thus satisfying the requirements on the charging speed by the high refresh rate and resolution.

Other features and advantages of the present disclosure will be further explained in the following description and partially become obvious therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

In order to explicitly explain the technical solution contained in the examples of the present disclosure, the drawings referred to in describing the examples are to be simply introduced as follows, wherein:

FIG. 1 is a diagram of voltage distribution of the dot reversion drive mode;

FIG. 2 schematically shows a display device provided in Embodiment 1 of the present disclosure; and

FIG. 3 schematically shows a display device provided in Embodiment 2 of the present disclosure.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It is important to note that as long as there is no structural conflict, all the technical features mentioned in all the embodiments may be combined together in any manner, and the technical solutions obtained in this manner all fall within the scope of the present disclosure.

The embodiments of the present disclosure provide a display device, comprising a plurality of scan lines and data lines that are staggered with each other vertically and horizontally, and a plurality of sub-pixel units defined by the scan lines and data lines. The display device further comprises an additional scan line, and an additional TFT. The additional TFT has its gate connected to the additional scan line, its source connected to the pixel electrode of a first sub-pixel unit, and its drain connected to the pixel electrode of a second sub-pixel unit. The polarities of voltages on the pixel electrodes of the first sub-pixel unit and the second sub-pixel unit are opposite to each other.

In the display process of the display device according to the embodiments provided in the present disclosure, the pixel electrodes of the first sub-pixel unit and the second sub-pixel unit can be electrically connected via the additional TFT by enabling the additional scan line in advance. In this case, the voltages on the two pixel electrodes with opposite polarities can be neutralized with each other to be approximate or equal to zero. Afterwards, when the corresponding scan line is enabled, the corresponding data lines will input data signals to the pixel electrodes of the two sub-pixel units, and the voltages on the two pixel electrodes will be charged from zero (or approximate zero) to values of correspondingly predetermined grayscales. As a result, voltage variation on the pixel electrodes is reduced, and the charging speed is improved, thus satisfying the requirements on the charging speed by the high refresh rate and resolution.

### Embodiment 1

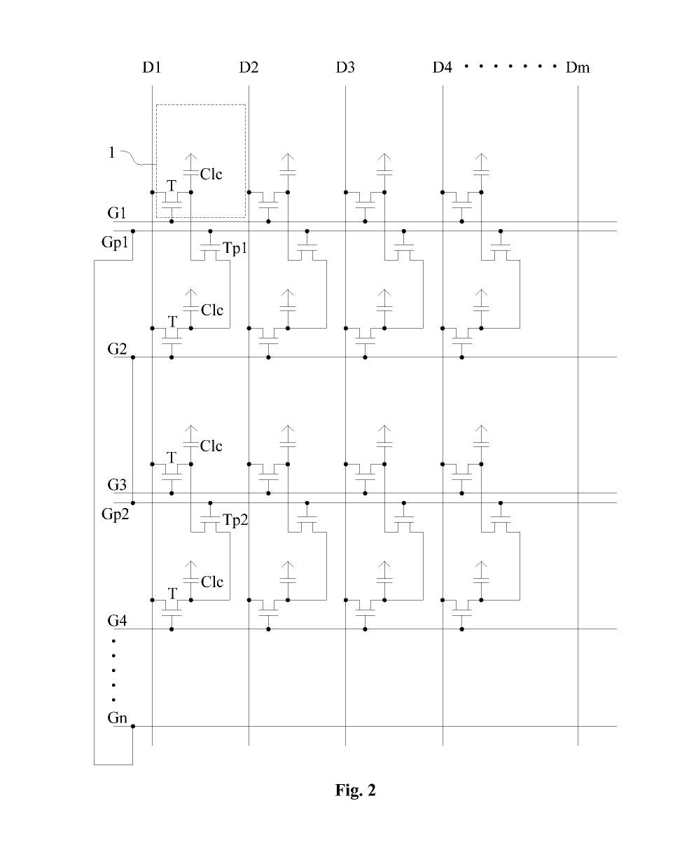

As indicated in FIG. 2, this embodiment of the present disclosure provides a display device, which can be a liquid crystal display television, a liquid crystal display, a mobile phone, a tablet personal computer, etc. The display device comprises n scan lines and m data lines that are staggered with each other horizontally and vertically, and n×m sub-pixel units 1 defined by the scan lines and data lines. The sub-pixel units each comprise a thin film transistor (TFT) and a pixel electrode, wherein the thin film transistor T has its gate connected to a respective scan line, its source connected to a respective data line, and its drain connected to the pixel electrode. When the scan line is enabled, the data signal on the respective data line can be input into the pixel electrode via the thin film transistor T, and a liquid crystal capacitor C1c is formed between the pixel electrode and the common electrode.

The display device further comprises an additional scan line and an additional TFT, wherein the additional TFT has its gate connected to the additional scan line, its source connected to the pixel electrode of a first sub-pixel unit, and its drain connected to the pixel electrode of a second sub-pixel unit, with the polarities of voltages on the pixel electrodes of the first sub-pixel unit and the second sub-pixel unit opposite to each other.

In the present embodiment, the first sub-pixel unit and the second sub-pixel unit are adjacent to each other. Specifically, the first sub-pixel unit is located at line i, column j, and the second sub-pixel unit is located at line i+1, column j, wherein 1≦i≦n−1, and 1≦j≦m. For example, in the embodiment as shown in FIG. 2, Tp1, as an additional TFT, has its gate connected to the additional scan line Gp1, its source connected to the pixel electrode of the sub-pixel unit located at line 1, column 1, and its drain connected to the pixel electrode of the sub-pixel unit located at line 2, column 1. When Gp1 is enabled, the pixel electrodes of the sub-pixel unit located at line 1, column 1 and the sub-pixel unit located at line 2, column 1 can be electrically connected via Tp1.

As one preferred solution, when 2≦i≦n−1, the additional scan line is connected to scan line i−1. For example, when i=3, additional scan line Gp2 is connected to the second scan line G2, so that Gp2 and G2 are signal synchronized, while Tp2 has its gate connected to Gp2, its source connected to the pixel electrode of the sub-pixel unit located at line 3, column 1, and its drain connected to the pixel electrode of the sub-pixel unit located at line 4, column 1. Gp2 is enabled at the same time when G2 is enabled, so that the pixel electrodes of the sub-pixel unit located at line 3, column 1 and the sub-pixel unit located at line 4, column 1 can be electrically connected via Tp2.

Furthermore, when i=1, the additional scan line is connected to scan line Gn, i.e., Gp1 is connected to Gn, so as to enable signal synchronization of Gp1 and Gn. When Gn is enabled, Gp1 is also enabled, so that the pixel electrodes of the sub-pixel unit located at line 1, column 1 and the sub-pixel unit located at line 2, column 1 can be electrically connected via Tp1.

This embodiment of the present disclosure further provides a method for driving the display device as described above. As an example, the dot reversion drive mode will be explained in detail in the following. In the dot reversion drive mode, each frame cycle can be divided into n scan cycles, with one scan line being enabled in each scan cycle, so that n scan lines are successively enabled in one frame cycle.

The dot reversion drive mode of the present embodiment comprises the following steps.

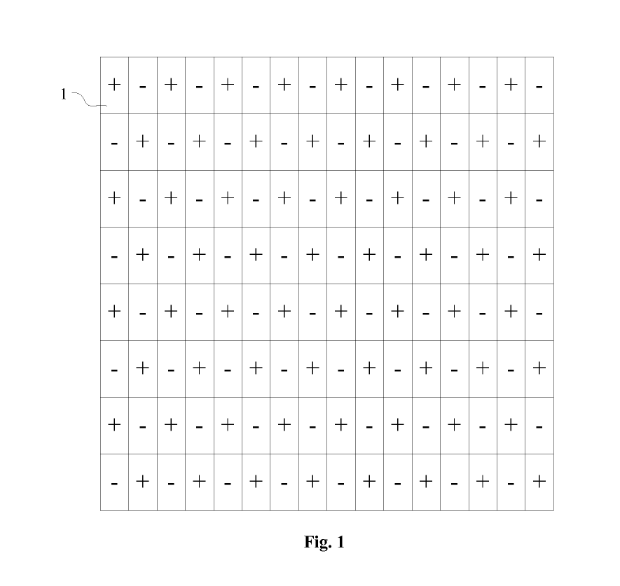

In a scan cycle before a present frame cycle begins, i.e., in the last scan cycle of a previous frame cycle, when Gn was enabled, data lines D1 to Dm each input data signals to the pixel electrodes of the respective sub-pixel units located in line n. Since Gp1 was connected to Gn, Gp1 was also enabled in this scan cycle, so that the pixel electrodes of the sub-pixel unit located at line 1, column 1 and the sub-pixel unit located at line 2, column 1 were electrically connected via Tp1. As shown in FIG. 1, the voltages of opposite polarities on the pixel electrodes of the sub-pixel unit located at line 1, column 1, and the sub-pixel unit located at line 2, column 1 were neutralized to be approximate or equal to zero.

Similarly, the voltages on the pixel electrodes of the sub-pixel unit located at line 1, column 2 and the sub-pixel unit located at line 2, column 2 were also neutralized to be approximate or equal to zero. It can thus be concluded that at each column of sub-pixel units, the voltages on the pixel electrodes of the sub-pixel unit located in line 1 and the sub-pixel unit located in line 2 were neutralized to be approximate or equal to zero.

Subsequently, the present frame cycle is started, wherein in the first scan cycle, the first scan line G1 is enabled, and the data lines each input data signals to the pixel electrodes of the respective sub-pixel units located in line 1. Since the voltages on the pixel electrodes of the sub-pixel units located in line 1 and line 2 were neutralized in the previous scan cycle, in the present scan cycle, the voltage on the pixel electrode of each of the sub-pixel units located in line 1 will be charged from approximate or equal to zero to a value of a predetermined grayscale. As a result, the variation quantity of voltage on the pixel electrode can be reduced, and the charging speed can be improved to meet the requirements of high refresh rate and high resolution.

In the second scan cycle of the present frame cycle, the second scan line G2 is enabled, and the data lines will each input data signals to the pixel electrodes of the respective sub-pixel units in line 2. Of course, the voltage on the pixel electrode of each of the sub-pixel units in line 2 will also be charged from approximate or equal to zero to a value of a predetermined grayscale, thus improving the charging speed thereof.

Meanwhile, Gp2 connected to G2 is also enabled, so that the pixel electrodes of the sub-pixel unit located at line 3, column 1 and the sub-pixel unit located at line 4, column 1 will be connected via Tp2, and the voltages of opposite polarities on the pixel electrodes of the two sub-pixel units will be neutralized to be approximate or equal to zero. Similarly, for each column of sub-pixel units, the voltages on the pixel electrodes of the sub-pixel units in lines 3 and 4 can be neutralized to be approximate or equal to zero.

In the third scan cycle of the present frame cycle, the third scan line G3 is enabled, and the data lines each input data signals to the pixel electrodes of the respective sub-pixel units in line 3.

In a similar way, before a data signal is input, the voltage on the pixel electrode of each sub-pixel unit can be neutralized with the voltage of an opposite polarity on the pixel electrode of its adjacent sub-pixel unit, thus improving the charging speed thereof.

In this embodiment, additional scan lines and additional TFTs are used to electrically connect the pixel electrodes of the sub-pixel units in line 1 to those of the respective sub-pixel units in line 2, and the pixel electrodes of the sub-pixel units in line 3 to those of the respective sub-pixel units in line 4, so on and so forth. In other embodiments, the positions of the additional scan lines and additional TFTs can be slightly changed, in order to electrically connect the pixel electrodes of the sub-pixel units in line 2 to those of the respective sub-pixel units in line 3, and the pixel electrodes of the sub-pixel units in line 4 to those of the respective sub-pixel units in line 5, so on and so forth. Such being the case, the voltage on the pixel electrodes of the sub-pixel units in line 1 cannot be neutralized in a similar way. Nevertheless, the additional scan line between the sub-pixel units in lines 2 and 3 can be directly connected to G1, so as to avoid the large span connection between Gp1 and Gn as demonstrated in Embodiment 1, and optimize wirings on the array substrate.

### Embodiment 2

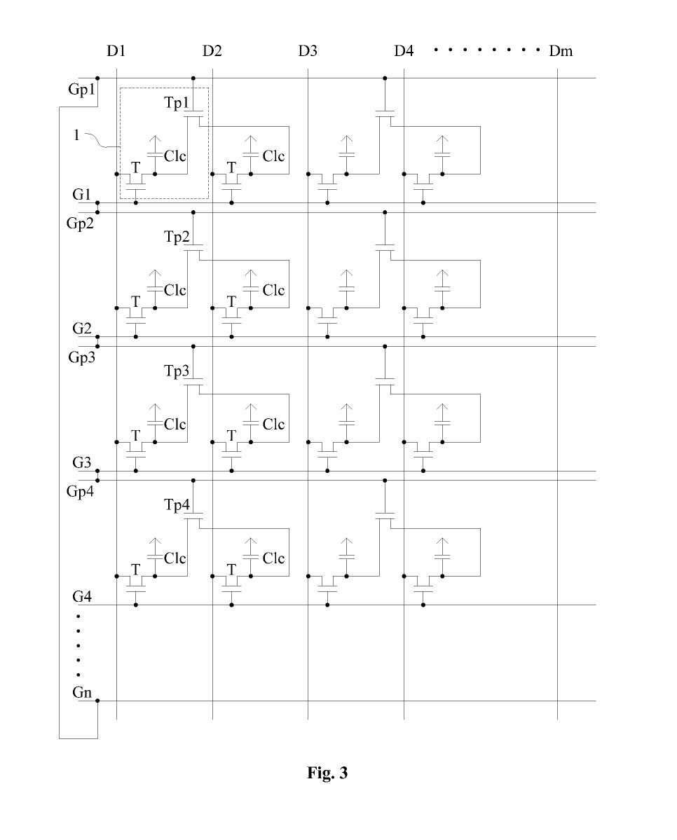

As indicated in FIG. 3, this embodiment of the present disclosure provides a display device, comprising n scan lines and m data lines that are staggered with each other horizontally and vertically, and n×m sub-pixel units 1 defined by the scan lines and data lines. The sub-pixel units each comprise a thin film transistor (TFT) and a pixel electrode, wherein the thin film transistor T has its gate connected to a respective scan line, its source connected to a respective data line, and its drain connected to the pixel electrode. When the scan line is enabled, the data signal on the respective data line can be input into the pixel electrode via the thin film transistor T, and a liquid crystal capacitor C1c is formed between the pixel electrode and the common electrode.

The display device further comprises an additional scan line and an additional TFT, wherein the additional TFT has its gate connected to the additional scan line, its source connected to the pixel electrode of a first sub-pixel unit, and its drain connected to the pixel electrode of a second sub-pixel unit, with the polarities of voltages on the pixel electrodes of the first sub-pixel unit and the second sub-pixel unit opposite to each other.

In the present embodiment, the first sub-pixel unit and the second sub-pixel unit are adjacent to each other. Specifically, the first sub-pixel unit is located at line i, column j, and the second sub-pixel unit is located at line i, column j+1, wherein 1≦i≦n, and 1≦j≦m−1. For example, in the embodiment as shown in FIG. 3, Tp1, as an additional TFT, has its gate connected to the additional scan line Gp1, its source connected to the pixel electrode of the sub-pixel unit located at line 1, column 1, and its drain connected to the pixel electrode of the sub-pixel unit located at line 1, column 2. When Gp1 is enabled, the pixel electrodes of the sub-pixel unit located at line 1, column 1 and the sub-pixel unit located at line 1, column 2 can be electrically connected via Tp1.

As one preferred solution, when 2≦i≦n−1, the additional scan line is connected to scan line i−1. For example, when i=2, additional scan line Gp2 is connected to the first scan line G1, so that Gp2 and G1 are signal synchronized, while Tp2 has its gate connected to Gp2, its source connected to the pixel electrode of the sub-pixel unit located at line 2, column 1, and its drain connected to the pixel electrode of the sub-pixel unit located at line 2, column 2. Gp2 is enabled at the same time when G1 is enabled, so that the pixel electrodes of the sub-pixel unit located at line 2, column 1 and the sub-pixel unit located at line 2, column 2 can be electrically connected via Tp2.

Furthermore, when i=1, the additional scan line is connected to scan line Gn, i.e., Gp1 is connected to Gn, so as to enable signal synchronization of Gp1 and Gn. When Gn is enabled, Gp1 is also enabled, so that the pixel electrodes of the sub-pixel unit located at line 1, column 1 and the sub-pixel unit located at line 1, column 2 can be electrically connected via Tp1.

This embodiment of the present disclosure further provides a method for driving the display device as described above. As an example, the dot reversion drive mode will be explained in detail in the following. In the dot reversion drive mode, each frame cycle can be divided into n scan cycles, with one scan line being enabled in each scan cycle, so that n scan lines are successively enabled in one frame cycle.

The dot reversion drive mode of the present embodiment comprises the following steps.

In a scan cycle before a present frame cycle begins, i.e., in the last scan cycle of a previous frame cycle, when Gn is enabled, data lines D1 to Dm each input data signals to the pixel electrodes of the respective sub-pixel units located at line n. Since Gp1 is connected to Gn, Gp1 is also enabled in this scan cycle, so that the pixel electrodes of the sub-pixel unit located at line 1, column 1 and the sub-pixel unit located at line 1, column 2 are electrically connected via Tp1. As shown in FIG. 1, the voltages of opposite polarities on the pixel electrodes of the sub-pixel unit located at line 1, column 1, and the sub-pixel unit located at line 1, column 2 are neutralized to be approximate or equal to zero.

Similarly, the voltages on the pixel electrodes of the sub-pixel unit located at line 1, column 3 and the sub-pixel unit located at line 1, column 4 are also neutralized to be approximate or equal to zero. It can thus be concluded that in the first line of sub-pixel units, the voltages on the pixel electrodes of each two adjacent sub-pixel units can be neutralized to be approximate or equal to zero.

Subsequently, the present frame cycle is started, wherein in the first scan cycle, the first scan line G1 is enabled, and the data lines each input data signals to the pixel electrodes of the respective sub-pixel units located in line 1. Since the voltages on the pixel electrodes of every two adjacent sub-pixel units located in line 1 have been neutralized in the previous scan cycle, in the present scan cycle, the voltage on the pixel electrode of each of the sub-pixel units located in line 1 will be charged from approximate or equal to zero to a value of a predetermined grayscale. As a result, the variation of voltages on the pixel electrode can be reduced, and the charging speed can be improved to meet the requirements of high refresh rate and high resolution.

At the same time, Gp2 connected to G1 is also enabled, and the pixel electrodes of the sub-pixel unit located at line 2, column 1, and the sub-pixel unit located at line 2, column 2 can be electrically connected via Tp2. Thus, the voltages of opposite polarities on the pixel electrodes of the two sub-pixel units can be neutralized with each other to be approximate or equal to zero. It can therefore be concluded that in line 2 of sub-pixel units, the voltages on the pixel electrodes of every two adjacent sub-pixel units can be neutralized with each other to be approximate or equal to zero.

In the second scan cycle of the present frame cycle, the second scan line G2 is enabled, and the data lines will each input data signals to the pixel electrodes of the respective sub-pixel units in line 2. Of course, the voltage on the pixel electrode of each of the sub-pixel units in line 2 will also be charged from approximate or equal to zero to a value of a predetermined grayscale, thus improving the charging speed thereof. Meanwhile, Gp3 connected to G2 is also enabled, so that the voltages on the pixel electrodes of every two adjacent sub-pixel units located in line 3 can be neutralized with each other to be approximate or equal to zero.

In a similar way, before a data signal is input, the voltage on the pixel electrode of each sub-pixel unit can be neutralized with the voltage of an opposite polarity on the pixel electrode of its adjacent sub-pixel unit, thus improving the charging speed thereof.

In other embodiments, Embodiments 1 and 2 can be combined together. For example, in one display device, for the first line of sub-pixel units, the additional scan line and the additional TFT thereof can be arranged in the way as illustrated in Embodiment 2, while for the second and third lines of sub-pixel units, the additional scan lines and the additional TFTs thereof can be arranged in the way as illustrated in Embodiment 1.

It should be noted that the display device of the embodiments according to the present disclosure can also be driven by the modes of common electrode line reversion, frame reversion, column reversion, etc. For example, the display device of Embodiment 2 can also be driven by the column reversion drive mode to enable voltage neutralization for the pixel electrodes of two sub-pixel units located in the same line but at two adjacent columns, thus improving the charging speed thereof.

In addition, two pixel electrodes respectively connected to the source and drain of an additional TFT can also be placed at two non-adjacent sub-pixel units. For example, in two-dot reversion or multi-dot reversion drive modes, the pixel electrodes of two remotely spaced sub-pixel units can be connected via an additional TFT.

The above embodiments are described only for better understanding, rather than restricting, the present disclosure. Any person skilled in the art can make amendments to the implementing forms or details without departing from the spirit and scope of the present disclosure. The scope of the present disclosure should still be subjected to the scope defined in the claims.

1. A display device, comprising a plurality of scan lines and data lines that are staggered with each other horizontally and vertically, a plurality of sub-pixel units defined by the scan lines and data lines, an additional scan line, and an additional TFT,
wherein the additional TFT has its gate connected to the additional scan line, its source connected to the pixel electrode of a first sub-pixel unit, and its drain connected to the pixel electrode of a second sub-pixel unit, and
wherein the polarities of voltages on the pixel electrodes of the first sub-pixel unit and the second sub-pixel unit are opposite to each other.

2. The display device of claim 1, wherein the first sub-pixel unit and the second sub-pixel unit are adjacent to each other.

3. The display device of claim 2, comprising n scan lines, m data lines, and n×m sub-pixel units, wherein the first sub-pixel unit is located at line i, column j, and the second sub-pixel unit is located at line i+1, column j, wherein 1≦i≦n−1, and 1≦j≦m.

4. The display device of claim 3, wherein when 2≦i≦n−1, the additional scan line is connected to scan line i−1.

5. The display device of claim 3, wherein when i=1, the additional scan line is connected to scan line n.

6. The display device of claim 2, comprising n scan lines, m data lines, and n×m sub-pixel units, wherein the first sub-pixel unit is located at line i, column j, and the second sub-pixel unit is located at line i, column j+1, wherein 1≦i≦n, and 1≦j≦m−1.

7. The display device of claim 6, wherein when 2≦i≦n, the additional scan line is connected to scan line i−1.

8. The display device of claim 6, wherein when i=1, the additional scan line is connected to scan line n.

9. A method for driving a display device, comprising:
Step 1: enabling an additional scan line so as to electrically connect the pixel electrodes of a first sub-pixel unit and a second sub-pixel unit via an additional TFT; and
Step 2: enabling a corresponding scan line so as to input data signals to the pixel electrodes of the first sub-pixel unit and the second sub-pixel unit.

10. The method of claim 9, comprising:
enabling a first scan line, during a first scan cycle of Step 2, so as to input a data signal to the pixel electrode of the first sub-pixel unit; and
enabling a second scan line, during a second scan cycle of Step 2, so as to input a data signal to the pixel electrode of the second sub-pixel unit.

11. The method of claim 9, comprising enabling the scan line, during the first scan cycle of Step 2, so as to input data signals to the pixel electrodes of the first sub-pixel unit and the second sub-pixel unit located in the same line.
